(19) United States
(12) Patent Application Publication
(10) Pub. No.: US 2014/0171673 A1
(43) Pub. Date: Jun. 19, 2014

(54) SYSTEMS AND METHODS OF REMOVING IMPURITIES FROM FATTY ACID METHYL ESTERS

(71) Applicant: GREEN EARTH FUELS, LLC, Houston, TX (US)

(72) Inventors: Mark Bauer, Houston, TX (US); Mark Tarrien, Houston, TX (US); Darcy Lefsrud, Houston, TX (US)

(73) Assignee: GREEN EARTH FUELS, LLC, Houston, TX (US)

(21) Appl. No.: 14/185,732

(22) Filed: Feb. 20, 2014

Related U.S. Application Data
(63) Continuation of application No. 12/726,631, filed on Mar. 18, 2010.

(51) Int. Cl. C11B 3/02; B01J 8/00

(52) U.S. Cl. CPC C11B 3/02; B01J 8/00
USPC 554/212; 422/211

(57) ABSTRACT

The present disclosure, in some embodiments, relates to systems and methods of treating biodiesel streams or fatty acid methyl ester streams. An example system for treating fatty acid methyl esters streams may comprise a fatty acid methyl ester stream and a strong acid catalyst resin vessel. The strong acid catalyst resin vessel may comprise a strong acid catalyst resin therein. The strong acid catalyst resin may have a density of about 30 lbs/ft³ to about 45 lb/ft³ within the strong acid catalyst resin vessel. The strong acid catalyst resin vessel may receive the fatty acid methyl ester stream, and may then output a treated fatty acid methyl ester stream

### CROSS REFERENCE TO RELATED APPLICATIONS

This application is a continuation-in-part of application Ser. No. 12/726,631, filed on Mar. 18, 2010, which claims priority to 61/161,575, filed on Mar. 19, 2009. The aforementioned applications are herein incorporated by reference in their entirety.

### FIELD OF THE DISCLOSURE

The present disclosure, in some embodiments, relates to systems and methods of treating biodiesel streams or fatty acid methyl ester streams. In particular, embodiments of the present disclosure may remove and/or reduce monoacylglycereol (monoglyceride) content in biodiesel streams or fatty acid methyl ester streams. In some embodiments, removable and/or reduction may be facilitated by an acid catalyst resin bed.

### BACKGROUND OF THE DISCLOSURE

Biodiesels may be fatty acid methyl ester (FAME) or long chain fatty acids derived through transesterification processes from substances such as vegetable oils or animals fats. For use as biodiesel products, biodiesels or FAME may first need to be processed to reduce or remove unwanted components. For example, elevated water content and precipitation of trace impurities in biodiesel streams may lead to difficulties in the blending of biodiesels with conventional diesel fuel. Reduction of water content and removal of impurities may be desired. As another example, removable of glycerin from a final product may be desired.

Biodiesel or FAME products may need to meet the specifications and requirements of various standard test methods. One such standard test method is ASTM D6584, which may be used to measure the amount of residual and bonded glycerin. More specifically, the ASTM D6584 may measure the monoglyceride content of a biodiesel stream or FAME stream through the use of an FID gas chromatograph.

Methods of removing water content and impurities from biodiesel or FAME streams may include washing crude biodiesel with glycerin, using a flocculating aid, increased water washing, more precise filtration, and cooling and filtering as well as use of a solid acid catalyst filter. Increased water washing may remove impurities. But, the excess water required may be significant and may be triple or quadruple the amount of water typically used along with longer overall cycle time. The higher water requirement may make the process impractical and not cost effective. Filtration alone may not improve biodiesel cold soak filtration times sufficiently for the biodiesel to meet specification.

### SUMMARY

Accordingly, a need has arisen for improved systems and methods for treating FAME and removing and/or reducing impurities therein. More specifically, a need has arisen for cost effective processes of producing biodiesel which meets the specifications and requirements of standard tests such as ASTM D6584.

The present disclosure, in some embodiments, relates to systems and methods of treating biodiesel streams or fatty acid methyl ester streams. An example system for treating fatty acid methyl esters streams may comprise a fatty acid methyl ester stream and a strong acid catalyst resin vessel. The strong acid catalyst resin vessel may comprise a strong acid catalyst resin therein. The strong acid catalyst resin may have a density of about 30 lbs/ft³ to about 45 lb/ft³ within the strong acid catalyst resin vessel. The strong acid catalyst resin vessel may receive the fatty acid methyl ester stream, and may then output a treated fatty acid methyl ester stream.

In some embodiments, a filter may be disposed downstream from the strong acid catalyst resin vessel. The filter may receive the treated fatty acid methyl ester stream from the strong acid catalyst resin vessel. The filter may be operable to remove solid acid catalyst resin fines from the treated fatty acid methyl ester stream.

In some embodiments, a system may further comprise a methanol stream in fluid communication with the first strong acid catalyst resin vessel. The methanol stream is operable to purge the first strong acid catalyst resin vessel.

In some embodiments, a system may further comprise a second strong acid catalyst resin vessel disposed downstream from the first strong acid catalyst resin vessel. The second strong acid catalyst resin vessel and the first strong acid catalyst resin vessel may be disposed in a lead-lag arrangement.

In some embodiments, the treated fatty acid methyl ester stream may comprise no more than trace amounts of monoglyceride content under the ASTM D6584 test. The temperature of the fatty acid methyl ester stream may be about 85° F. to about 120° F. The solid acid catalyst resin may be a solid acid catalyst capable of removing monoglycerides. Examples of solid acid catalyst resins may include Rohm & Haas A-35 (dry), BD-20 (dry), Dowex DR-2030 (dry) or Dowex Monosphere DR-2030 (dry).

In some embodiments, monoglyceride component contained on the solid acid catalyst resin may be directly esterified into fatty acid methyl esters during methanol regeneration of the solid acid catalyst resin. Purging of the first strong acid catalyst resin vessel may produce an output stream, wherein the output stream may substantially comprise methanol and fatty acid methyl esters. Systems may further comprise a vacuum dryer, wherein the vacuum dryer may be configured to separate a fatty acid methyl ester content and a methanol content of the output stream. In some embodiments, the fatty acid methyl ester content may be recycled back into the fatty acid methyl ester stream, and the methanol content may be recycled back into the methanol stream.

The present disclosure further provides for methods of treating fatty acid methyl ester streams. Methods may comprise receiving a fatty acid methyl ester stream at a strong acid catalyst resin vessel, and outputting a treated fatty acid methyl ester stream from the strong acid catalyst resin vessel. The first strong acid catalyst resin vessel may comprise a strong acid catalyst resin. The strong acid catalyst resin may have a density of about 30 lbs/ft³ to about 45 lb/ft³ within the first strong acid catalyst resin vessel.

Methods of treating fatty acid methyl ester streams may further comprise receiving the treated fatty acid methyl ester stream at a filter, and removing solid acid catalyst resin fines from the treated fatty acid methyl ester stream using the filter. Methods may further comprise purging the first strong acid catalyst resin vessel with a methanol stream. Methods may further comprise disposing a second strong acid catalyst resin vessel downstream from the first strong acid catalyst resin vessel. The second strong acid catalyst resin vessel and the first strong acid catalyst resin vessel may be disposed in a lead-lag arrangement.

### BRIEF DESCRIPTION OF THE DRAWINGS

FIG. 1 is a schematic representation of a system for treating biodiesel according to one embodiment of the present disclosure;

FIG. 2A is a schematic representation of a system for treating biodiesel according to another embodiment of the present disclosure;

FIG. 2B is a schematic representation of a system for treating biodiesel according to another embodiment of the present disclosure;

FIG. 3 is a flowchart diagram depicting a method according to one embodiment of the present disclosure; and

FIG. 4 is a flowchart diagram depicting a method according to one embodiment of the present disclosure.

### DETAILED DESCRIPTION

The present disclosure relates, in some embodiments, to processes of treating biodiesel or FAME streams. Unless otherwise specified, all quantities, percentages and ratios herein are by weight. Materials for the equipment of the process may be suitable metals such as carbon steel or stainless steel. In some embodiments, heat exchangers may be stainless steel.

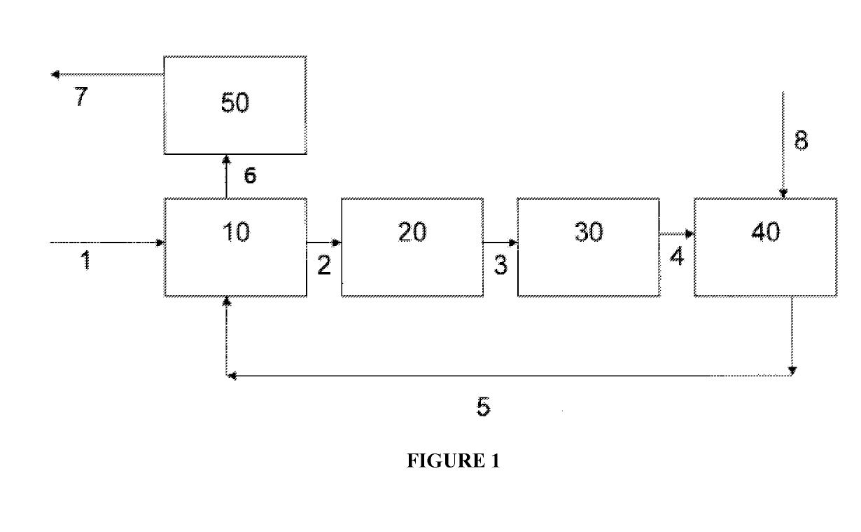

A schematic representation of a system for treating biodiesel according to one embodiment of the present disclosure is shown in FIG. 1. As shown in FIG. 1, FAME stream 1 may be cooled via a heat exchanger 10 to produce a cooled FAME 2. The cooled FAME 2 may have a temperature ranging from about 0° F. to about 20° F. (about −17.8° C. to about −6.7° C.). In some embodiments, the temperature may range from about 3° F. to about 5° F. (about −16.1° C. to about −15° C.) above the cloud point of the FAME 1. The starting temperature of biodiesel 1 may range from about 85° F. to about 120° F. (about 29.4 to about 48.9° C.). In some embodiments, the temperature of the FAME 1 may be about 105° F. (about 40.6° C.). The temperature of the cooled FAME 2 exiting the heat exchanger 10 may range from about 40° F. to about 80° F. (about 4.4 to about 26.7° C.). The temperature of the cooled FAME 2 exiting heat exchange 10 may be dependent upon the temperature of FAME 1 entering heat exchanger 10.

The FAME 1 may be produced from any vegetable, plant or animal fat or oil. For example, the FAME 1 may be produced from tallows, palm and palm oil blends, soy, canola, rapeseed, camelina, sunflower seed oil, cottonseed oil, algae oils, yellow grease, and/or poultry fats. In some embodiments, the FAME 1 may preferably have a total glycerin number not exceeding about 0.24% weight as determined by ASTM D6584.

The heat exchanger 10 may be any type of heat exchanger that may be operable to cool the FAME 1 to a desired temperature of the cooled FAME 2. In some embodiments, the heat exchanger 10 may be a pair of heat exchangers. More specifically, the pair of heat exchanges may comprise a first exchanger and a second exchanger arranged sequentially. The first exchanger may act as an economizer and may pre-cool the FAME 1 with a treated FAME 5. The first exchanger may lower the temperature of the FAME 1 from between about 120° F. and about 85° F. to between about 75° F. and about 60° F. The temperature difference may be dependent upon the temperature of FAME 1 entering the first exchanger. The second exchanger may use a chilled heat transfer fluid to further lower the temperature of the FAME. The temperature of the FAME may be lowered to between about 40° F. and about 75° F. The drop in temperature from the second exchanger may be dependent upon a drop in temperature achieved in the first exchanger. In some embodiments, the second exchanger may use a propylene glycol/water chiller fluid. One of ordinary skill in the art having the benefit of the present disclosure would appreciate that a wide variety of other known heat transfer fluids may be used without departing from the scope of the present disclosure. In some embodiments of the present disclosure, one or more additional heat exchangers may be utilized.

In some embodiments, the cooled FAME 2 may be directed to a retention tank 20. The retention tank 20 may preferably be sized to hold the cooled FAME 2 for about 2.5 hours to about 5 hours. In some embodiments, a longer retention time may promote the precipitation and density phase separation of impurities. The retention time may be adjusted to allow for cold partial precipitation of impurities in the cooled FAME 2, including impurities such as sterol glucosides and monoglycerides. A chilled FAME 3 may exit from the retention tank 20 after a sufficient retention time has passed.

In some embodiments, the chilled FAME 3 may be directed from the retention tank 20 to a chilled biodiesel filter 30. The chilled biodiesel filter 30 may promote production of a filtered FAME 4. In some embodiments, the chilled FAME 3 may be filtered to target about 95% removal of particles based on particle size distribution of the chilled FAME 3. The filter pore size may range from between about 1 micron to about 20 microns. In some embodiments, the filter pore size may range from between about 1 micron to about 5 microns. In some embodiments, the chilled FAME 3 may be filtered to remove about 95% of particles greater than about 1 micron in size. The chilled biodiesel filter 30 may be any filter capable of filtering to the required pore size, such as but not limited to cartridge and sock filters. The chilled biodiesel filter 30 may be a multiunit sock filter sized to handle of flow rate of about 120 gpm flow of the chilled biodiesel 3. Processing the chilled FAME 3 through the chilled biodiesel filter 30 may result in a filtered FAME 4.

The filtered FAME 4 may be passed through an ion exchange resin vessel 40 to produce a treated FAME 5. In some embodiments, there may be two ion exchange resin vessels arranged in a lead-lag arrangement. The ion exchange vessel 40 may be filled with a solid acid catalyst. The solid acid catalyst may have sites with an affinity for binding to residual impurities in the filtered FAME 4. In some embodiments, the impurities may include sterol glucosides, monoglycerides, water, soap, free glycerin, and metals.

The solid acid catalyst may be any macroporous strong acid catalyst resin able to absorb hydroxyl groups of organic compounds. In some embodiments, the strong acid catalyst resin may be dry. In some embodiments, the strong acid catalyst resin t may be a DOW BDA-35 dry resin. In some embodiments, the strong acid catalyst resin may be Rohm & Haas A-35 (dry), BD-20 (dry), Dowex DR-2030 (dry) or Dowex Monosphere DR-2030 (dry). The wet forms of solid acid catalyst resins may also be used. If a wet form of a solid acid catalyst resin is used, in some embodiments, the resin may be dried prior to placing into service.

One of ordinary skill in the art having the benefit of the present disclosure would appreciate that various solid acid catalyst may be used. Different solid acid catalysts may advantageously promote the removal of different impurities in a biodiesel or FAME stream. Selection of a strong acid catalyst resin may be based on various characteristics such as particle size, surface area, average pore diameter, total pore volume, moisture content, etc. In some embodiments, a chosen strong acid catalyst resin may have a moisture content of equal to or less than 3%. A chosen strong acid catalyst resin may have a particle size of 15 to 50 mesh. A chosen strong acid catalyst resin may have a total pore volume of about 0.3 cc/g to about 0.4 cc/g. A chosen strong acid catalyst resin may have a surface area of about 30 m²/g to about 50 m²/g. The aforementioned characteristics and ranges are described by way of example only. One of ordinary skill in the art having the benefit of the present disclosure would appreciate that various solid acid catalyst resins may be used or chosen without departing from the scope of the present disclosure.

Processing the filtered FAME 4 through the ion exchange vessel 40 may result in treated FAME 5. Treated FAME 5 may be passed through heat exchanger 10 to produce a heated FAME 6. In some embodiments, the temperature of the heated FAME 6 may have the final product storage temperature, ranging from about 70° F. to about 120° F. In some embodiments, the temperature may range from about 95° F. to about 100° F. The heated FAME 6 may be sent through a finishing filter 50. The finishing filter 50 may remove any solid acid catalyst resin fines present in the treated FAME 5 to produce a final product 7. In some embodiments, finishing filter 50 may remove about 95% of particles based on particle size distribution of the product. The finishing filter may have a pore size between about 1 micron and about 5 microns. In some embodiments, the pore size may be about 1 micron.

The final product 7 of the present disclosure may meet the specifications of the Cold Soak Filtration Test method (ASTM D6751-08). The final product 7 may have reduced amounts of sterol glucosides and monoglyceride content as compared to that of the FAME stream 1. The reduction and/or removal may be from a concentration as high as about 0.8% down to less than about 0.4 wt %. In some embodiments, the final concentration may be about 0.15 wt % or about 0.01%. Monoglyceride content may be measured using an FID gas chromatograph with the ASTM method D6584. Typical water content for the final product 7 may ranges from about 39 ppm to about 159 ppm.

When the resins in the ion exchange vessel 40 are exhausted, they may be regenerated using IMPCA grade methanol to remove sterols and monoglycerides that are bound to the resin. To regenerate, the ion exchange resin vessel 40 may be purged with methanol 8. The resins may be washed with about three (3) bed volumes of methanol over about six (6) hours. The resin beds of the ion exchange resin vessel 40 may then be purged of methanol and flushed with two (2) bed volumes of filtered biodiesel 4 prior to being placed back into service.

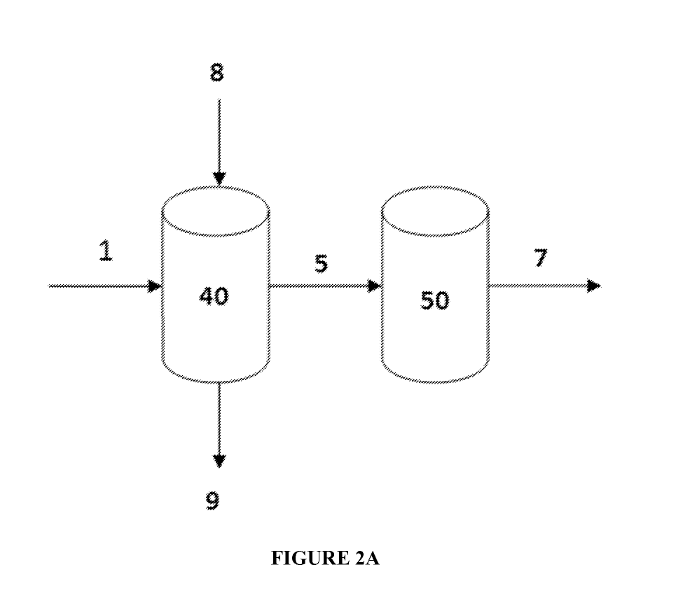

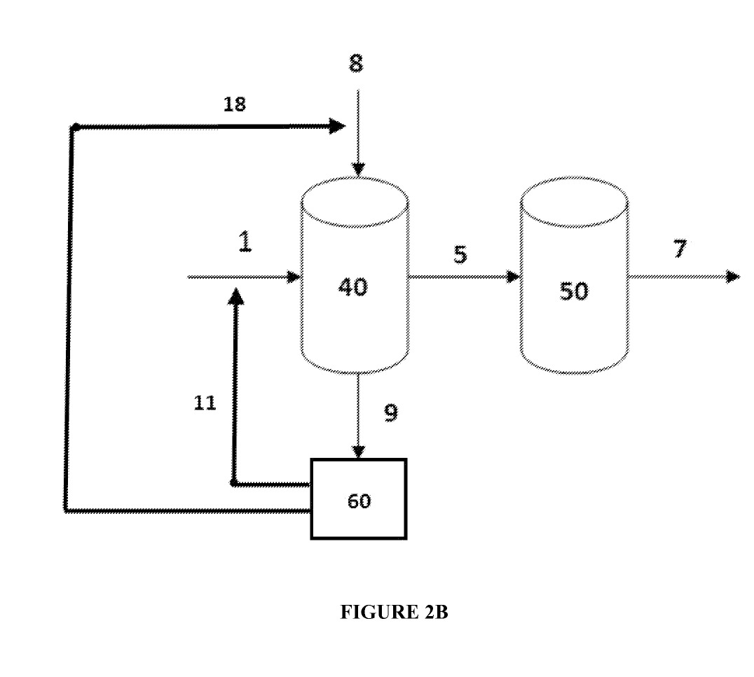

FIG. 2A and FIG. 2B are schematic representations of systems for treating biodiesel or FAME streams according to another embodiment of the present disclosure. Referring to FIG. 2A and FIG. 2B, the FAME stream may enter the strong acid catalyst resin vessel 40 directly. FAME 1 may enter the system at a starting temperature in the range of about 85° F. to about 120° F. (about 29.4° C. to about 48.9° C.). In some embodiments, the temperature of FAME 1 may be about 105° F. (about 40.6° C.). Accordingly, in some embodiments, pretreatment or cooling of FAME 1 may not be necessary prior to being passed through a resin vessel.

As shown in FIG. 2A and FIG. 2B, the FAME stream 1 may be passed through the ion exchange resin vessel 40. In some embodiments, the ion exchange resin vessel 40 may be a strong acid catalyst resin vessel 40. The strong acid catalyst resin vessel 40 may advantageously promote processing of the FAME 1 to produce the treated FAME 5. In some embodiments, the impurities may predominantly be monoglycerides. The strong acid catalyst resin may be a macroporous spherical type with an affinity for binding monoglycerides in FAME stream 1. Explained differently, the solid acid catalyst resin may be a solid acid catalyst capable of removing monoglycerides by containing said monoglycerides within the solid acid catalyst.

As previously described, the strong acid catalyst resin may be any macroporous strong acid resin able to adsorb hydroxyl groups of organic compounds. In some embodiments, the strong acid resin may be dry. In some embodiments, the strong acid resin may be a DOW BDA-35 dry resin. In some embodiments, the strong acid catalyst resin may be Rohm & Haas A-35 (dry), BD-20 (dry), Dowex DR-2030 (dry) or Dowex Monosphere DR-2030 (dry). The wet forms of solid acid catalyst resins may also be used. In some embodiments where a wet form of a solid acid catalyst resin is used, the resin may be dried prior to being placed into service.

One of ordinary skill in the art having the benefit of the present disclosure would appreciate that various solid acid catalyst may be used. Different solid acid catalysts may advantageously promote the removal of different impurities in a biodiesel or FAME stream. Selection of a strong acid catalyst resin may be based on various characteristics such as particle size, surface area, average pore diameter, total pore volume, moisture content, etc. In some embodiments, a chosen strong acid catalyst resin may have a moisture content of equal to or less than 3%. A chosen strong acid catalyst resin may have a particle size of 15 to 50 mesh. A chosen strong acid catalyst resin may have a total pore volume of about 0.3 cc/g to about 0.4 cc/g. A chosen strong acid catalyst resin may have a surface area of about 30 m²/g to about 50 m2/g. The aforementioned characteristics and ranges are described by way of example only. One of ordinary skill in the art having the benefit of the present disclosure would appreciate that various solid acid catalyst resins may be used or chosen without departing from the scope of the present disclosure.

In some embodiments, a system for FAME or biodiesel treatment may comprise one or more strong acid catalyst resin vessels. Explained differently, the strong acid catalyst resin vessel 40 may comprise one or more vessels therein. For example, an embodiment may comprise two strong acid catalyst resin vessels. Said vessels may be arranged in a lead-lag arrangement. Thus, some embodiments may comprise a first strong acid catalyst resin vessel and a second strong acid catalyst resin vessel. One of ordinary skill in the art having the benefit of the present disclosure would appreciate that a plurality of vessels used may share common characteristics and features described herein. Thus, for example, the second strong acid catalyst resin vessel may comprise resin having the same characteristics as those previously described pertaining to the first strong acid catalyst resin. However, the plurality of resin vessels may or may not necessarily comprise the same volume, resin concentration, or other operating characteristics. Providing for a plurality of strong acid catalyst resin vessels disposed in sequence or in some other arrangement may advantageously provide for various benefits. For example, utilizing a plurality of resin vessels may advantageously decrease the volume requirements of each individual vessel. In some embodiments, utilizing a plurality of resin vessels may advantageously increase or otherwise adjust the time needed for bed regenerations. Various aspects of the resin vessel 40 or vessels may be adjusted without departing from the scope of the present disclosure.

The FAME stream 1 may exit the strong acid catalyst resin vessel 10 as treated FAME 5. Treated FAME 5 may be directed to enter final filter 50. Explained differently, strong acid catalyst resin vessel 40 and the final filter 50 may be in fluid communication with one another. The final filter 50 may serve to remove any solid acid catalyst resin ‘fines’ which may be present in the treated FAME 5. Processing of treated FAME 5 may produce final product 7. In some embodiments, final filter 50 may be a duplex multi bag type housing with large double reinforced bag filters. Reinforced bag filters may be advantageous in the case of resin screen failure inside of the resin vessels. The final filter 50 may advantageously provide protection from vessel support failure. Vessel support failure, or failure of holding the resin in the vessel, may lead to a lost of resin down a pipeline into a storage tank. Such vessel support failure may result in undesirable costs and processes associated with clean up and disposals. Various aspects of the final filter 50 may be adjusted without departing from the scope of the present disclosure.

Treatment of the FAME stream 1 through strong acid catalyst resin vessel 40 may advantageously produce a FAME stream with no detectable amounts or only trace amounts of monoglyceride content. Accordingly, treated FAME 5 and/or the final product 7, as shown in FIG. 2A and FIG. 2B, may have no detectable amounts or only trace amounts of monoglyceride content. Monoglyceride content may be measured using an FID gas chromatograph with ASTM method D6584. Water content of the final product 7 may range from about 10 ppm to about 300 ppm. Accordingly, embodiments of the present disclosure may advantageously be effective at removing water content in biodiesels or FAME streams.

The resin in the strong acid catalyst resin vessel 40 may become exhausted. Explained differently, the resin may no longer remove monoglycerides to a degree required or a degree that may be efficient. When exhaustion occurs, the resin may be regenerated using IMPCA grade methanol to directly convert monoglycerides that are bound to the resin to FAME via acid esterification reactions. To regenerate, the strong acid catalyst resin vessel 40 may be purged with methanol stream 8. The resins may be reacted with about three (3) bed volumes of methanol over a time frame of about six (6) hours. The resin beds of the strong acid catalyst resin vessel 40 may then be purged of unreacted methanol and biodiesels or FAME by flushing with three (3) bed volumes of biodiesel stream 1. A FAME methanol mix 9 may exit the resin vessel 40 as the strong acid catalyst resin vessel 40 is emptied. FAME methanol mix 9 may then be directed towards several possible outlets. For example, the FAME methanol mix 9 may exit to a dryer to strip residual methanol from FAME; to a wash phase of FAME 1 processing; or to the reaction phase of FAME 1 processing. Once the strong acid catalyst resin vessel 40 has been regenerated with methanol 8 and resulting FAME methanol mix 9 may have been purged by three (3) bed volumes of FAME 1, the strong acid catalyst resin vessel 10 may be ready to be put back in service.

In some embodiments, a time in-between bed regenerations of the strong acid catalyst resin vessel 40 may be extended by increasing the resin concentration or amount of resin therein. The strong acid catalyst resin vessel 40 may comprise about 20,000 lbs to about 30,000 lbs of strong acid catalyst resin. In some embodiments, the strong acid catalyst resin vessel 40 may comprise about 25,750 lbs of strong acid catalyst resin. One of ordinary skill in the art having the benefit of the present disclosure would appreciate that an advantageous resin concentration may be dependent upon the size of the strong acid catalyst resin vessel 40 chosen. Thus, although no upper bound is provided herein for the resin concentration, additional resin may be disposed within a strong acid catalyst resin vessel 40 and such additional resin may advantageously promote the removal of impurities from an FAME or biodiesel stream.

The volume of the strong acid catalyst resin vessel 40 and the concentration of resin therein may be adjusted to achieve various design considerations without departing from the scope of the present disclosure. A higher resin density may advantageously promote longer bed regeneration time intervals and may advantageously promote efficient removal of impurities. In some embodiments, a strong acid catalyst resin may have a density of about 30 lbs/ft³ to about 45 lb/ft³. In some embodiments, a strong acid catalyst resin may have a density of about 38 lbs/ft³. The volume of the strong acid catalyst resin vessel 40 may be sized to advantageously allow for up to 100% expansion of resin during a regeneration process.

In some embodiments, the strong acid catalyst resin vessel 40 comprising about 25,750 lbs of resin may treat about 420,000 gallons to about 1,260,000 gallons of FAME. One of ordinary skill in the art having the benefit of the present disclosure would appreciate that the efficiency of a FAME treatment system may depend on an impurity load or impurity concentration in the FAME or biodiesel stream.

Referring to FIG. 2B, embodiments of the present disclosure may advantageously provide for systems with little to no waste. As previously described, methanol stream 8 may be used to purge the strong acid catalyst resin vessel 40. During the purging process, monoglycerides contained in or captured within the solid acid catalyst resin may be directly esterified into fatty acid methyl esters during methanol regeneration of the solid acid catalyst resin. Accordingly, stream 9 may be a FAME methanol mix comprising substantially only fatty acid methyl esters and methanol. Advantageously, due to the strong acid functionality of the catalyst resin and a large molar excess of methanol, the entrained monoglycerides captured in the resin may be directly acid esterified to fatty acid methyl esters during regeneration. Thus, FAME methanol mix stream 9 may comprise little to no monoglycerides or other impurities extracted from the original FAME stream 1.

The FAME methanol mix stream 9 may be further treated in processing unit 60 to separate the fatty acid methyl esters content from the methanol content of stream 9. Processing unit 60 may be a vacuum dryer. The vacuum dryer 60 may be configured to pull residual water and methanol overhead and to condense said residual water and methanol. The methanol/water condensate may then be pumped to a decant/distillation system where the methanol/water condensate may be fed to a methanol tower to recover methanol. Accordingly, substantially all contents of the FAME methanol mix stream 9 may be recycled back into the process. The recycled FAME stream 11 may be recycled back and mixed with the original FAME stream 1. The recycled methanol stream 18 may be recycled back and mixed with the methanol stream 8. Said mixture of the recycled methanol stream 18 and methanol stream 8 may be put back in service and be utilized for subsequent purging of the strong acid catalyst resin vessel 40. Recovered water may also be reused in a FAME water wash process.

It should be further appreciated that, embodiments of the present disclosure may provide for systems exhibiting low waste and high recycling. Accordingly, in some embodiments, once sufficient FAME stream 1 and methanol stream 8 are provided, the system may continue to operate without a constant need for additional fatty acid methyl esters. In some embodiments, recycled FAME stream 11 alone may be sufficient. In some embodiments, recycled FAME stream 11 may be fed directly into the strong acid catalyst vessel 40.

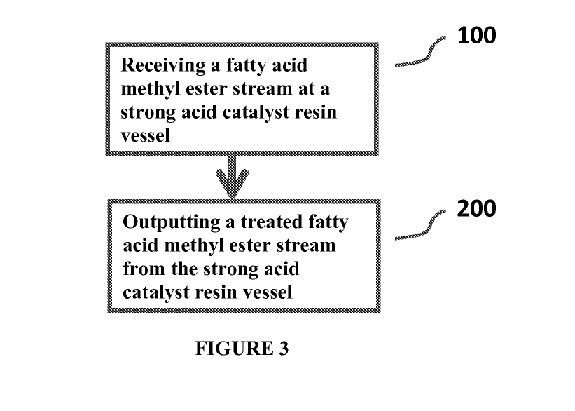

Another aspect of the present disclosure provides for methods of treating FAME or methods of operating the aforementioned and described systems of treating FAME or biodiesel streams. Methods may advantageously provide for removal of impurities from FAME or biodiesel streams, including impurities such as monoglycerides. As shown in FIG. 3, methods may comprise receiving a fatty acid methyl ester stream at a strong acid catalyst resin vessel 100. Methods may further comprise outputting a treated fatty acid methyl ester stream from the strong acid catalyst resin vessel 200. In some embodiments, the treated fatty acid methyl ester stream may advantageously have no more than trace amounts of monoglyceride content when tested under the ASTM D6584 test. Accordingly, methods of the present disclosure may advantageously provide for a treated FAME stream or a product FAME stream comprising significantly less impurities.

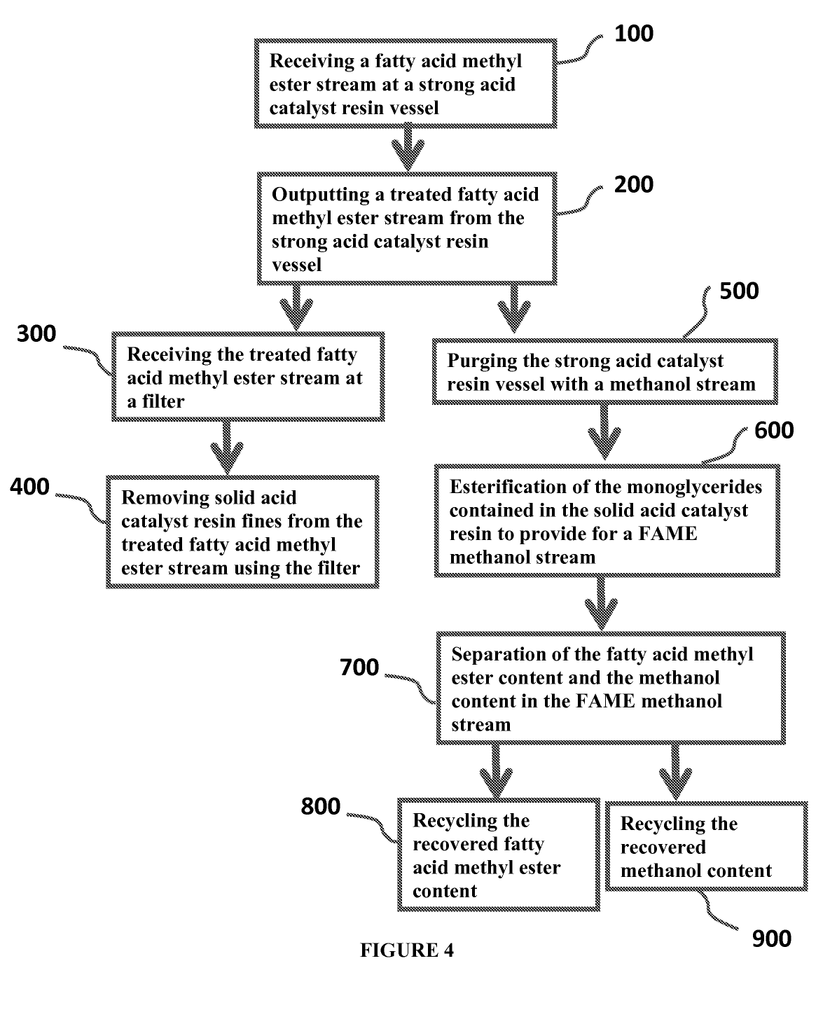

In some embodiments, methods of the present disclosure may comprise additional steps or features. For example, as shown in FIG. 4, methods may comprise receiving a treated fatty acid methyl ester stream at a filter 300. Said treated fatty acid methyl ester stream may be provided from a strong acid catalyst resin vessel. Methods may further comprise removing solid acid catalyst resin fines from the treated fatty acid methyl ester stream using the filter 400. The filter may advantageously promote the removal of solid acid catalyst resin fines from the treated fatty acid methyl ester stream. As shown in FIG. 4, methods may also comprise purging the strong acid catalyst resin vessel with a methanol stream 500.

Methods of the present disclosure may advantageous provide for recycling of recovered FAME and methanol content. As previous described, monoglycerides contained in or captured within the solid acid catalyst resin may be directly esterified into fatty acid methyl esters during methanol regeneration of the solid acid catalyst resin. Accordingly, methods may comprise esterification of the monoglycerides contained in the solid acid catalyst resin to provide for FAME methanol stream 600. Said FAME methanol stream may be a FAME methanol mix comprising substantially only fatty acid methyl esters and methanol. The FAME methanol stream may comprise little to no monoglycerides.

Methods may further comprise separation of the fatty acid methyl ester content in the FAME methanol stream and the methanol content in the FAME methanol stream 700. Once separated, the recovered fatty acid methyl ester may be recycled back into the original FAME stream 800. Similarly, the recovered methanol may be recycled back into the original methanol stream 900 for use in subsequent purging of the resin vessel. One of ordinary skill in the art having the benefit of the present disclosure would appreciate that the present disclosure provides for methods that may advantageously achieve little to no waste, and allow for high amounts of recycling.

It should be appreciated that the methods depicted in FIG. 3 and FIG. 4 are provided by way of example only. Various changes or additions may be made to the methods or steps thereof without departing from the scope of the present disclosure. For example, purging the strong acid catalyst resin vessel with a methanol stream 500 may occur before, after, or concurrently with receiving the treated fatty acid methyl ester stream at a filter 300.

One or ordinary skill in the art having the benefit of the present disclosure would appreciate that the present disclosure provides for various embodiments for treating fatty acid methyl ester streams. For example, systems may be applied to the treatment of fatty acid methyl ester streams of varying composition. Thus, the present embodiments may be used on fatty acid methyl ester streams that already meet the ASTM D6751 requirements (and may thus be referred to as “biodiesel”). Embodiments for treating biodiesels may nonetheless further improve the purity of the fatty acid methyl ester stream. Such improvements may be accomplished by further removal of impurities such as monoglycerides.

As will be understood by those skilled in the art having the benefit of the present disclosure, other equivalent or alternative methods and systems for treating biodiesel streams and FAME streams can be envisioned without departing from the scope of the present disclosure. Accordingly, the manner of carrying out the disclosure as shown and described is to be construed as illustrative only.

Persons skilled in the art may make various changes in the shape, size, number, and/or arrangement of parts without departing from the scope of the present disclosure. For example, the position and number of heat exchangers, resin vessels, and final filters may be varied. In some embodiments, strong acid catalyst resins may be interchangeable. Interchageability may allow the system to be custom adjusted to target certain impurities. In addition, the size of a device and/or system may be scaled up or down to suit the needs and/or desires of a practitioner. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Persons skilled in the art may make various changes in methods of preparing and using a composition, device, and/or system of the disclosure.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100.

All or a portion of a device and/or system for processing biodiesel streams and FAME streams may be configured and arranged to be disposable, serviceable, interchangeable, and/or replaceable. These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

1. A system for treating fatty acid methyl esters streams, the system comprising:
a fatty acid methyl ester stream;
a first strong acid catalyst resin vessel;
wherein the first strong acid catalyst resin vessel comprises a strong acid catalyst resin;
wherein the strong acid catalyst resin has a density of about 30 lbs/ft³ to about 45 lb/ft³ within the first strong acid catalyst resin vessel;
wherein the first strong acid catalyst resin vessel receives the fatty acid methyl ester stream; and
wherein first strong acid catalyst resin vessel outputs a treated fatty acid methyl ester stream.

2. The system of claim 1, further comprising
a filter disposed downstream from the first strong acid catalyst resin vessel;
wherein the filter receives the treated fatty acid methyl ester stream from the first strong acid catalyst resin vessel; and
wherein the filter removes solid acid catalyst resin fines from the treated fatty acid methyl ester stream.

3. The system of claim 1, further comprising
a second strong acid catalyst resin vessel disposed downstream from the first strong acid catalyst resin vessel;
wherein the second strong acid catalyst resin vessel and the first strong acid catalyst resin vessel are disposed in a lead-lag arrangement.

4. The system of claim 1, wherein the treated fatty acid methyl ester stream comprises no more than trace amounts of monoglyceride content under the ASTM D6584 test.

5. The system of claim 1, wherein the temperature of the fatty acid methyl ester stream is about 85° F. to about 120° F.

6. The system of claim 1, wherein the solid acid catalyst resin is a solid acid catalyst capable of removing monoglycerides.

7. The system of claim 1, further comprising
a methanol stream in fluid communication with the first strong acid catalyst resin vessel such that the methanol stream is operable to purge the first strong acid catalyst resin vessel.

8. The system of claim 7, wherein purging the first strong acid catalyst resin vessel produces an output stream, and wherein the output stream substantially comprises methanol and fatty acid methyl esters.

9. The system of claim 8, further comprising
a vacuum dryer,
wherein the vacuum dryer is configured to separate a fatty acid methyl ester content and a methanol content of the output stream.

10. The system of claim 9, wherein the fatty acid methyl ester content is recycled into the fatty acid methyl ester stream, and wherein the methanol content is recycled into the methanol stream.

11. A method for treating fatty acid methyl esters streams, the method comprising:
receiving a fatty acid methyl ester stream at a first strong acid catalyst resin vessel;
outputting a treated fatty acid methyl ester stream from the first strong acid catalyst resin vessel;
wherein the first strong acid catalyst resin vessel comprises a strong acid catalyst resin; and
wherein the strong acid catalyst resin has a density of about 30 lbs/ft³ to about 45 lb/ft³ within the first strong acid catalyst resin vessel.

12. The method of claim 11, further comprising
receiving the treated fatty acid methyl ester stream at a filter;
removing solid acid resin catalyst fines from the treated fatty acid methyl ester stream using the filter.

13. The method of claim 11, further comprising
disposing a second strong acid catalyst resin vessel downstream from the first strong acid catalyst resin vessel;
wherein the second strong acid catalyst resin vessel and the first strong acid catalyst resin vessel are disposed in a lead-lag arrangement.

14. The method of claim 11, wherein the treated fatty acid methyl ester stream comprises no more than trace amounts of monoglyceride content under the ASTM D6584 test.

15. The method of claim 11, wherein the temperature of the fatty acid methyl ester stream is about 85° F. to about 120° F.

16. The method of claim 11, wherein the solid acid catalyst resin is a solid acid catalyst capable of removing monoglycerides

17. The method of claim 11, further comprising
purging the first strong acid catalyst resin vessel with a methanol stream.

18. The method of claim 17, wherein purging the first strong acid catalyst resin vessel produces an output stream, and wherein the output stream substantially comprises methanol and fatty acid methyl esters.

19. The method of claim 18, further comprising
separating, using a vacuum dryer, a fatty acid methyl ester content and a methanol content of the output stream.

20. The method of claim 19, further comprising
recycling the fatty acid methyl ester content into the fatty acid methyl ester stream, and
recycling the methanol content into the methanol stream.
